(19) United States
(12) Patent Application Publication
(10) Pub. No.: US 2010/0080143 A1
(43) Pub. Date: Apr. 1, 2010

(54) System and Method for Testing Mobile Telephone Data Services

(76) Inventors: Dimitrios M. Topaltzas, Ellicott City, MD (US); Rupert C. Lloyd, Reston, VA (US)

Correspondence Address: CAPITAL LEGAL GROUP, LLC, 1100 River Bay Road, Annapolis, MD, 21409, US

(21) Appl. No.: 12/242,309

(22) Filed: Sep. 30, 2008

(51) Int. Cl. H04W 24/08

(52) U.S. Cl. 370/253

(57) ABSTRACT

A system and method of determining the quality of data services of a mobile telephone is provided. In one embodiment, a method comprises wirelessly receiving content as data stream of data packets at the mobile telephone via a mobile telephone network, storing the received data packets in a memory, storing in the memory reception sequence data comprising data of the sequence of reception of each data packet received, storing in a memory reception timing data comprising data of the timing of the reception of each packet received, reconstructing the data stream by providing the data packets to an end user application in a sequence determined by the reception sequence data and spaced apart in time as determined by the reception time data, presenting the content with the end user application, and determining a quality assessment of the content based on the output of the end user application. The end user application may be resident on a mobile telephone device or a computer. The presentation by the end user device may be recorded and processed by quality assessment program code and/or a panel of observers to provide a quality assessment.

### FIELD OF THE INVENTION

The present invention generally relates to systems and methods for evaluating communication devices, and more particularly to systems and methods for evaluating the performance of mobile telephone devices in the reception of various data types via a mobile telephone network.

### BACKGROUND OF THE INVENTION

As mobile telephones proliferate, and as mobile telephone networks develop, various digital communication services are being introduced, including various data communications services. Many of the data communication services are packet-based data services used to access the internet, such as to communicate text messages, video files, audio files, email and other data.

Until recently most conventional internet access services, such as those available in the home or office, have been delivered via a wire or cable and enjoy a highly consistent transmission quality. In contrast mobile telephone devices are subjected to use under varying radio environments which results in highly varying transmission quality and thus highly varying data service performance to the end user.

One challenge to those designing mobile telephone devices is to design the telephone devices to provide the desired data quality even when the user is using the telephone device in challenging and changing radio environments. Further, wireless network operators want users of their network to use telephone devices that provide adequate communication quality in all radio environments to ensure that the user has a satisfactory experience using the wireless network.

There are a wide variety of telephone devices capable of providing one or more forms of data communications. With the proliferation of mobile telephone devices, many designs of telephones have evolved. The different designs of telephone devices result in different performance characteristics for each telephone device. Various design characteristics may impact the quality of the data services provided by a telephone device. For example, the radio front-end of a telephone device, which drives, in part, the radiated performance (a devices ability to receive and transmit radio signals) of the device may positively or negatively impact the quality of data communications in various radio environments. Another factor may be the device's capability to cancel interfering radio signals from wanted radio signals in order to improve the signal-to-noise ratio and thereby improve the quality of communications. Other design factors include (a) the performance of the device's digital signal processor, (b) the design of the device's operating system and associated applications including the handling of TCP/IP communication. As a result, the many different mobile telephone devices have varying performance characteristics due to their design. Thus, different telephone devices operating in the same radio environment may provide different qualities of data communication.

A challenge to mobile telephone device manufacturers, and to wireless carriers, is how to evaluate the relative performance of mobile telephone devices for the various packet data services. Another challenge is to objectively compare the communication quality of different mobile telephone devices in a consistent manner.

A generic method for measuring and automating performance indicators would be to mount a mobile telephone to a fixture where a video camera records the handset's display (and audio output). The video of the handset's performance could then be viewed by a panel of people or by an expert and the quality determined on a subjective basis. However, such a process is inadequate and fraught with problems. For example, because the mobile telephone is in the field (e.g., in a vehicle), while recording the mobile telephone the camera also will capture environmental sounds (e.g., sounds of the vehicle, horns beeping, nearby trucks, etc.) and external visual inputs (e.g., sunlight, reflections, changes in ambient light (day versus night), etc.), all of which will differ over time and in different locations. Thus, such a method cannot adequately and objectively assess the communication qualities provided by mobile telephones.

The present invention provides methods and systems to objectively test the various communication qualities of different mobile telephone devices. These and other advantageous may be provided by one or more embodiments of the present invention.

### SUMMARY OF THE INVENTION

The present invention provides a system and method for determining the quality of data services of a mobile telephone. In one embodiment, a method comprises wirelessly receiving content as data stream of data packets at the mobile telephone via a mobile telephone network, storing the received data packets in a memory, storing in the memory reception sequence data comprising data of the sequence of reception of each data packet received, storing in a memory reception timing data comprising data of the timing of the reception of each packet received, reconstructing the data stream by providing the data packets to an end user application in a sequence determined by the reception sequence data and spaced apart in time as determined by the reception time data, presenting the content with the end user application, and determining a quality assessment of the content based on the output of the end user application. The end user application may be resident on a mobile telephone device or a computer. The presentation by the end user device may be recorded and processed by quality assessment program code and/or a panel of observers to provide a quality assessment.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an example system for testing data services provided by a mobile telephone device according to an example embodiment of the present invention;

FIG. 2 illustrates an example method for testing data services provided by a mobile telephone device communicating through a mobile telephone network, according to an example embodiment of the present invention;

FIG. 3 illustrates data flow in example method for testing data services provided by a mobile telephone device communicating through a mobile telephone network, according to an example embodiment of the present invention; and

FIG. 4 illustrates additional processes that may be performed during testing of data services provided by a mobile telephone device communicating through a mobile telephone network, according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, telephone devices, mobile telephones, accessory devices, simulators, ear pieces, headsets, payloads, telephone handsets, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, telephone devices, mobile telephones, accessory devices, simulators, ear pieces, payloads, headsets, telephone handsets, terminals, devices, components, techniques, data and network protocols, software products and systems, development interfaces, operating systems, and hardware are omitted so as not to obscure the description of the present invention.

According to an embodiment of the present invention, the performance of a mobile telephone device, such as a mobile telephone, is evaluated for the reception of various data types. As used herein, “mobile telephone” means a telephone configured to communicate voice and data over a mobile telephone network. Other telephone devices include mobile telephone accessories (e.g., a wired or wireless) such as an earpiece, headset, speaker phone (e.g., that includes a microphone and which may be, for example, in an automobile, or other device), or other such device. A mobile telephone, also sometimes commonly referred to as a cell telephone, is a long-range, mobile electronic device used for mobile communications. In addition to providing the standard voice function of a telephone, many mobile telephones support data services such as SMS for text messaging, email, FTP, UDP, packet switching for access to the Internet, and MMS (Multimedia Messaging Service) for sending and receiving photos and video. A conventional mobile telephone may wirelessly communicate via a cellular network of base stations (cell sites), which is connected to the public switched telephone network (PSTN). A mobile telephone device thus may include a mobile telephone alone, or in combination with an accessory. Such mobile telephone devices include hardware and software that wirelessly receive data signals and convert the wirelessly received signals to a form and format suitable for an end user application (e.g., convert the received signals to digital data packets). Such hardware and software will determine, in whole or part, the reception capabilities of the mobile telephone device. Various embodiments of the present invention may be implemented to objectively test and compare such hardware and software of a wide variety of mobile telephone devices.

The present invention may be used to evaluate various data communications such as the reception of voice over IP (VoIP), non-voice audio content (e.g., streaming audio such as digital radio), and video content (e.g., streaming video), which in some instances comprises content that normally is presented to the user in real-time (e.g., presented substantially as the data is received). Various performance indicators may be used to quantify the reception capabilities of the tested device. For example, measurement of performance indicators may include time to download/upload, time to present a web page, quality of video, quality of audio, and others.

In an example embodiment of the present invention, a test application residing on a mobile telephone device is executed by test personnel. The application causes the mobile telephone device to transmit a request for content to a remote device (e.g., a server) via a mobile telephone network. The remote device responds by transmitting content in data packets. For each data packet transmitted, the remote device stores a packet sequence number, a time (e.g., in milliseconds offset from the first data packet), and (in some embodiments) the packet size (e.g., in bytes)—collectively referred to herein as transmission parameters. In some embodiments, the packets sequence numbers are sequential and, therefore, the packet sequence data of the transmission parameters (for the transmitted data packets) may comprise only the first and last packet sequence number.

The mobile phone device receives and stores data of the received packets forming the content in a log file. More specifically, each data packet received the test application on the mobile telephone device stores various data in the log file such as, for example, a packet sequence number, a reception time (e.g., time in milliseconds offset from reception of the first data packet), and (in some embodiments) the packet size (e.g., in bytes)—collectively referred to herein as reception parameters. Other data may also be stored such as a bit error rate, reception (data) rate, number of lost packets, and other communication parameters relating to the communication. In one embodiment, the reception parameters are sufficient to allow the received communication to be reconstructed at some later time in a manner that provides substantially the same listening and/or viewing experience as the original user experience. In particular, latencies, moments of decreased quality and other variations from the ideal end user experience may be captured, reproduced, and/or assessed.

The log file (e.g., containing the reception parameters) may be transmitted, uploaded or otherwise provided to a processing system for analyzing the log file to provide a statistical quality analysis of the data reception of the mobile telephone. In addition, or alternately, the log file (e.g., containing the reception parameters) may be transmitted, uploaded or otherwise provided to a processing system to reconstruct the data stream, which is provided to an end user application for presenting the content a perceived quality analysis of the data reception of the mobile telephone. For example, the mobile telephone device may send the log file to a computer at a test center via the mobile telephone network, and/or the internet. The test center computer system then executes a test process to evaluate the log file. The result corresponds to the quality of the data communications occurring at the mobile telephone device under test.

Differing processing procedures may be selected by the test personnel. In one example, the received data stream is reconstructed from the data packets and data of the log file and provided to a server-based end user application. For example, end user applications similar to those found on the mobile telephone device (such as windows media player, or skype (VOIP), or internet explorer, may be used to format and play back the data content. In another example the reconstructed data stream is input to a mobile telephone device under laboratory conditions for evaluating the end user experience. For either of these examples the content being reconstructed and played back may be recorded. Alternatively or in addition, the content may be observed by one or more evaluators. For example, a panel of evaluators may give their subjective analysis of the reconstructed playback experience (either of the recording of the output or of a live presentation of the reconstructed data stream). Alternatively or in addition, an image processing program may be executed to objectively evaluate the visual quality, and/or an audio processing program may be executed to objectively evaluate the audio quality, as applicable, of the reconstructed (and in some instances recorded) content. These analyses provide a perceived quality analysis of the data reception capabilities of the mobile telephone. Thus, the perceived quality analysis assesses the quality of the presentation of the content (typically the quality of analog data) by assessing the output of an end user application receiving the reconstructed data stream.

In still another example, as an alternative or additional evaluation process, the log file may be processed separately (e.g., without the need to reconstruct the data stream) to provide a statistical quality analysis. For example, the data communication quality of the mobile telephone device may be evaluated by obtaining and analyzing the packet sequence, time between packets, error rates, and other communication parameters associated with the data communications. In one example, the reception parameters may be processed with (e.g., compared against) the transmission parameters to assess the quality of the communication.

Example objective results may include, but are not limited to one or more of time to download/upload, time to view a web page, quality of video, quality of audio, bit transfer rate (e.g., peak and/or average throughput), connectivity (e.g., which may result in either success or failure), latency, jitter, error rate, PESQ, MOS, lost packets, connectivity loss, etc. Exemplary subjective results may be ratings using a predefined scale which rate video quality, audio quality, noise, dropped frames, et cetera. In addition, the objective and subjective results may be encoded (and stored) with a time and date stamp of the data reception, a GPS position of the mobile telephone device receiving the data communication, and with information for uniquely identifying the mobile telephone device tested (e.g., the telephone number of the mobile telephone device, International Mobile Equipment Identity (IMEI); model and serial numbers).

The same mobile telephone device may be tested at various locations within a given mobile telephone network. Similarly, different mobile telephone devices and different device configurations for a given mobile telephone may be tested to compare how well different devices and device configurations perform in the network. Further, testing may be performed for different mobile telephone devices in different mobile telephone networks to determine and compare how well the mobile telephone devices perform among the different networks.

One advantage of the present invention is that a user may select from among a plurality of content types (e.g., VoIP, HTML, Video, Audio) and protocols. Numerous files and files types may be included as test files and transferred during a test to evaluate the data service quality of the mobile telephone device for a given mobile telephone network. Another advantage is that the test results may be centrally stored in a results database. The results may be accessed for viewing immediately or at some later time by one or more authorized users.

### Test System Environment

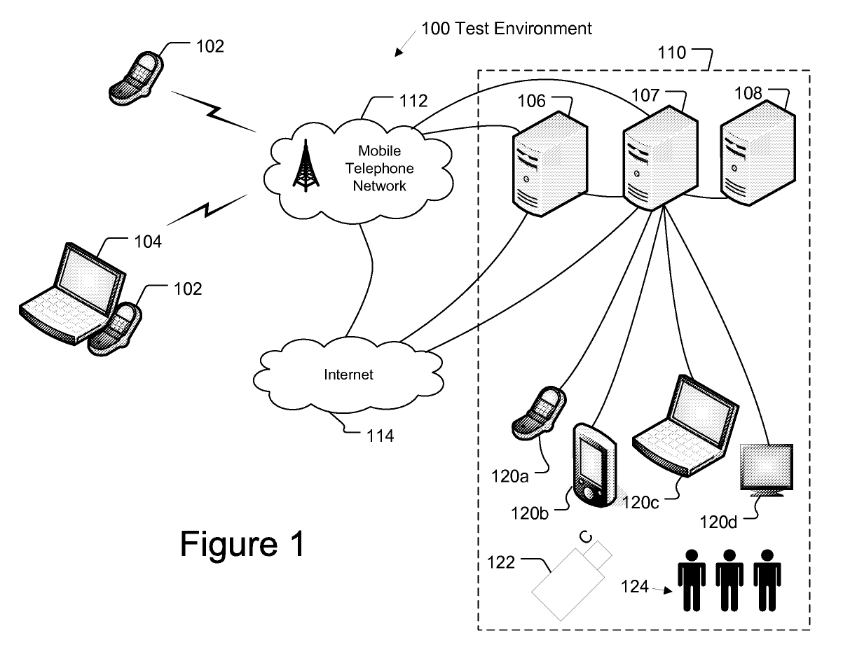

FIG. 1 shows an example embodiment of a test system environment 100 for testing a mobile telephone device 102. The mobile telephone device 102 may be tested alone or may be connected to a portable computer 104 that executes the test application for testing the mobile telephone device. Thus, the test system environment 100 may include the mobile telephone device 102 being tested, a portable computer 104 (in some implementations), as well as one or more test center computers and communication networks. In an example embodiment, the test center computer system may include one or more media servers 106, test servers 107, and database servers 108. The communication networks may include a mobile telephone network 112 and other networks (e.g., the internet 114).

The media servers 106 are configured to store and transmit a plurality of test files that may include different types of media files such as, for example purposes only, audio (i.e., non-voice over IP), video (such as video having an audio component), and voice files. The test servers 107 may be used to control the operation of the test process. The database servers 108 may store test parameters, test results, and other data. While FIG. 1 depicts these as separate devices 106-108, in practice the functions of these servers and computers may be performed by a single physical computer that uses different software (e.g., server software) to perform the associated functionality or by multiple computers performing each function that are not co-located. In other words, the servers/computers are depicted as separate components in FIG. 1 for ease of explanation, but any suitable means of providing the functions described herein may be employed and fall within the scope of the present invention. As used herein, the term “computer” is meant to include a computer system that includes one or more physically separate computing devices (e.g., servers, desk tops, lap tops, rack mounted, etc.) that may or may not be co-located with each other. Further, although the various computers 106-108 are shown in a common test center 110, the devices 106-109 may be located in different physical locations. The various computers 106-108 may communicate with each other directly, through a local area network, through a wide area network, or through a global network (e.g., the internet).

During testing, the mobile telephone device 102 may communicate with the various computers of the test center 110 through a communication path that includes the mobile telephone network 112. The mobile telephone network 112 may be a radio network made up of a number of radio cells (or just cells) each served by a fixed transmitter, known as a cell site or base station. These cells are used to cover different areas in order to provide radio coverage over a wider area than the area of one cell. An exemplary mobile telephone network 112 may be based on any of various telecommunication standards, such as AMPS, D-AMPS, CDMA2000, GSM, GPRS, EV-DO, UMTS, WiMAX, G1, G1.5, G2, and G3. The communication path also may include an internet protocol (IP) network, a broadband communication network, a Wifi network (e.g., IEEE 802.11a/b/g/n), a WiMAX network, and/or another wired or wireless network coupled to the internet 114 and capable of digital communications (not shown). Thus, the present invention may be used to test the communications of a mobile telephone device provided by its Wifi transceiver (in addition to testing communications of its mobile telephone network transceiver).

The test server 107 may perform the test functions that may be required at the test center 110 end of the communication path for the particular test, and/or cooperate with another server to perform the functions. For example, in response to a request for content from the mobile telephone device 102, the test server 107 may cause another server such as the media server 106 to transmit one or more test files (comprising the content) to the mobile telephone device 102.

Test files comprising content transmitted to a mobile telephone device 102 being tested are transmitted (and received) as a plurality of data packets (e.g., a video data stream). For each data packet transmitted, the test server 107 (or alternately the media server 106) stores in a log file a packet sequence number, a time (e.g., number of milliseconds offset from the time of transmission of the first data packet), and (in some embodiments) the packet size (e.g., in bytes)—collectively referred to herein as transmission parameters.

The mobile phone device receives the content and stores data of the received data packets in a local log file. More specifically, for each data packet received the test application on the mobile telephone device stores in the local log file a packet sequence number, a time (e.g., number of milliseconds offset from reception of the first data packet), and (in some embodiments) the packet size (e.g., in bytes)—collectively referred to herein as reception parameters. Packet size may be used if the system does not use checksums and partial packets are transmitted. Other data also may be stored such as a bit error rate, reception (data) rate, cumulative reception time, time and date, GPS location, telephone number, and other communication parameters relating to the communication. In other embodiments, the data packets themselves may also be stored in the log file (or separately) to be provided to the test center 110

The local log file for a given test may be transmitted to the test center 110 from the mobile telephone device 102 (or portable computer 104) where the test server 107 performs a process for evaluating the test. The various operations performed by the test center 110 are described in detail below. The test results and log file may be stored in the database servers 108.

The database servers 108 may function as a repository of test results. For example, upon completion of a test, the log file, test results, a test identifier, a mobile telephone device identifier, a GPS location (of the mobile telephone 102 during the test), and a time and date stamp may be stored in memory (in association with each other) of the database server 108. Test results may include, for example, a MOS value, download/upload, error rate, time to view a web page, quality of video, quality of audio, bit transfer rate (e.g., peak and/or average throughput), connectivity (e.g., which may result in either success or failure), latency, jitter, error rate, packets lost, connectivity loss, subjective ratings, etc. and/or one or more other perceived and/or statistical quality analysis parameters.

To access the test results a user may, for example, login to the database server 108 via the Internet 114. In an example embodiment, tests results from multiple tests may be grouped logically as projects. One or more users may be authorized to access the results. In addition to storing test results and allowing users to log in to access test results, the database server 108 also may perform post-processing operations to extract significant metrics, and to organize and report results. Results may be transmitted to the mobile telephone device 102 or associated portable computer 104 for viewing. In one embodiment, test results may be transmitted automatically upon completion of a test to the mobile telephone device in substantially real time (i.e., as soon as the results are available). In another embodiment, a user may view the results through a web interface.

Various statistics may be derived from the various test results. Reports may aggregate statistics, for example, by the specific test, by the specific mobile telephone device 102, for a group of mobile telephone devices, for all mobile telephone devices 102 associated with a given project, etc. Mobile telephone devices 102 may be grouped, for example, by make, model, form factor, antenna type, network, band, radio technology, operating system, and/or chip set to allow comparisons.

### Test Methods

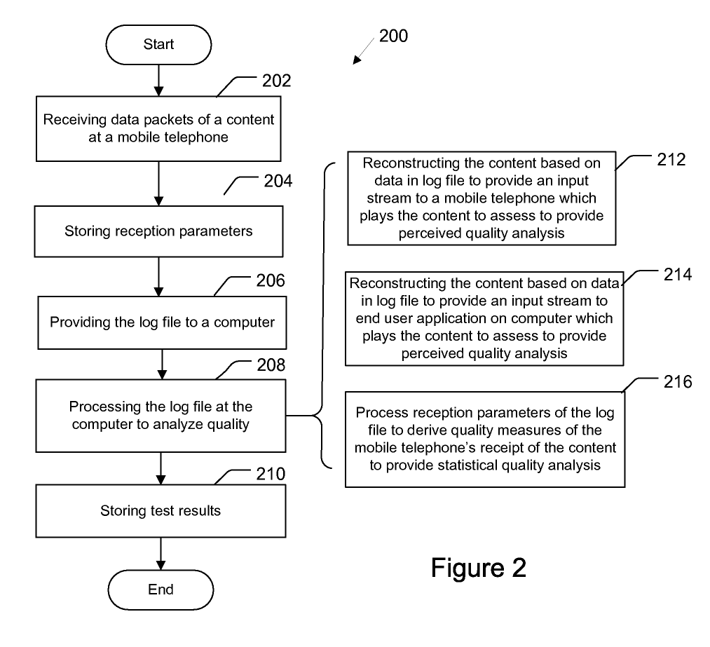

FIG. 2 illustrates an example process 200 performed for testing data communications between a mobile telephone device 102 and a test center (e.g., media server 106) according to an example embodiment of the present invention. As described above, an end user may request to perform a test of a data service by selecting an appropriate command from a test menu of the mobile telephone device 102. The request may cause a test application resident on the mobile telephone device (or local portable computer 104) to cause the mobile telephone device to transmit a request for content to the test center 110, where the test server 107 processes the request. According to the specific request, the test server 107 may cause the media server 106 to transmit selected content to the mobile telephone device 102.

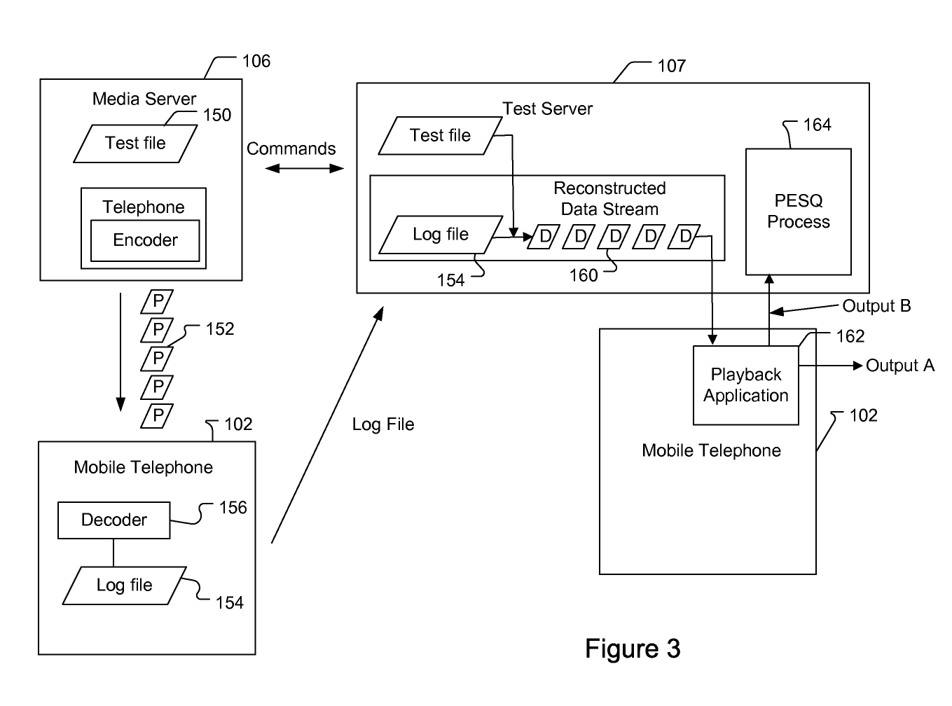

Content (comprising one or more test files) transmitted via the mobile telephone network is received by the mobile telephone device 102 in the form of data packets at step 202. FIG. 3 shows a data flow diagram in which a test file 150 comprising content is transmitted from the media server 106 as a sequence of data packets 152. As shown in FIG. 3, the media server 106 may be coupled to a mobile telephone network by a telephone, modem or other device. The test file 150 may include original source media, such as, for example, a WAV file. The media server 106 or test server 107 also may define the type of codec used to encode the test file content for transmission, and any parameters that may control how the codec encodes the test file content. For each data packet transmitted, the test server 107 (or alternately the media server 106) stores in a log file transmission parameters.

The mobile telephone device 102 receives the incoming data packets 152 at step 202. For example, the packets 152 may be received via a decoder 156. At step 204 the reception parameters are stored in the log file and may include (for each data packet received) a packet sequence number, a time (e.g., number of milliseconds offset from reception of the first data packet), and the packet size (e.g., in bytes) for each data packet received. In some instances, other data may also be stored (or derived) such as a bit error rate, a throughput rate, total download time, packets lost, and other parameters.

After reception of the content and storage of the reception parameters, the log file 154 is provided to the test center 110 for analysis at step 206. In various embodiments, the log file 154 may be transmitted through the mobile telephone network 112 and/or the internet 114 to the test server 107 directly or indirectly. At step 208, the test server 107 processes the log file 154 to analyze the quality of the data communications received by the mobile telephone device 102. Such analysis serves as an evaluation of the data service provided by the mobile telephone device 102 in the radio conditions existing at the time and location of the test. In this embodiment, the test server 107 may retrieve the content transmitted as well as a transmission log file that includes the transmission parameters in order to process the log file received from the mobile telephone. In other embodiments, the data packets containing the content may be provided to the test server 107 from the mobile telephone. At step 210, the test results of the analysis may be stored on the data server 108, where they may be accessed by test personnel, and various reporting and/or analysis programs.

The processing performed by the test server 107 at step 208 may be varied. In one embodiment a process 212 may be performed in which the content formed by the received data packets is reconstructed from the log file 154 and output according to the reception parameters (e.g., the packet sequence and timing information (and if necessary the packet size) stored upon reception) to provide an input stream of the data packets forming the content to a mobile telephone device 120a that substantially matches the input stream of data packets received by the mobile telephone device 102 that originally received the test file. In other words, the test server 107 may provide the data packets to a mobile telephone in a sequence determined by the reception packet sequence data (of the log file) and spaced apart in time as determined by the reception time data (of the log file). As an example, if the mobile telephone received a first set of data packets out of sequence and did not receive another set of data packets (the data packets were lost), the test server 107 would provide the data packets to the mobile telephone in the same manner with the first set of packets out of sequence and the second set of data packets omitted. The test server 107 may include settings that model receipt of the data packets—in effect buffering inputs, compensating for jitter, delay, dropped packets, and out of sequence packets. Thus, the stored log file is used to reconstruct the data stream in a manner that substantially replicates the original reception of the data.

The appropriate software on the mobile telephone receiving the reconstructed data stream plays the incoming data stream. More specifically, the data stream 160 (see FIG. 3) representing the reconstructing content may be input to an end user application 162 of the mobile telephone, such as an internet browser, audio player, video player, voice decoder, or other application program. The output (for example, Output A or B) of the end user application 162 may be analyzed to thereby provide a perceived quality analysis.

In another test process, the process 214 may be performed without using a mobile telephone device. For example, the reconstructed data stream 160 may be input to an end user application 162 being executed by an alternative computing device, such as a personal digital assistant 120b, or notebook computer 120c. Still further, the end user application 162 may be executed by the test server 107 resulting in content being displayed on a display device 120d and/or audio device. Accordingly, processing of the log file 154 may result in data 160 being presented (played) by any suitable output device 120, which is quality analyzed to thereby provide a perceived quality analysis.

In yet another test process, a process 216 may be performed in which the log file 154 itself is processed (without regard for whether the content is played back or not) to provide a statistical quality analysis. For example, the reception parameters of the log file 154 may be processed based on the transmission parameters to assess a quality of the received data stream. Thus, determining a quality assessment (i.e. a statistical quality assessment) may comprise processing the received reception timing data, transmission timing data, reception sequence data, and/or transmission sequence data. For example, by determining the first and last packet sequence number of the transmitted packets, the process 216 can determine which packets have been lost. In addition, because (in this embodiment) the transmitted data packets have packet sequence numbers that are sequential, the process can determine that data packets are received out of order if the order of the reception does not match the data packet sequence numbers of the received data packets.

In addition, reception timing data may be compared with transmission timing data to determine reception delays. Thus, for example, the log file may be processed to determine the percentage of data packets received out of sequence, the percentage of packets lost, the average and mean delay between data packets, the percentage of data packets received more than a predetermined time after the previous data packet, the percentage of data packets received with an incorrect size, and/or other quality assessment. Depending on the embodiment and implementation thereof, the present invention may incorporate any combination or all of the processes 212, 214, and 216 and may include providing both a statistical and perceived quality analysis.

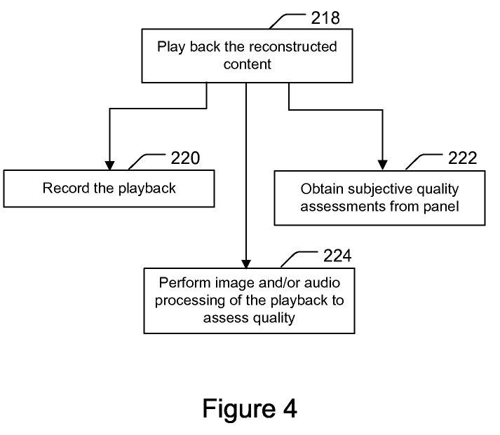

FIG. 4 shows various steps that may be performed as part of processes 212 and 214 to provide a perceived quality analysis. At step 218 the content formed by the data stream 160 reconstructed from the log file 154 is played back at an output device 120. In some embodiments, the playback may be recorded at step 220. For example, a camera 122 (see FIG. 1) may record video playback or audiovisual playback. In the case of an audio communication without video output, an audio recording device may be used to record the playback.

In some embodiments a panel 124 of people may observer the playback and provide evaluations, ratings, and analyses of the playback at step 222. For example, the panel 124 may follow an objective protocol to document their subjective impressions. In various scenarios, the panel 124 may view the playback as originally re-constructed and played (at step 212 or 214) or from the recording at step 220.

In some embodiments the processes 212 and 214 may include using an image processing program and/or audio processing program at step 224 to analyze the playback for jitter, noise, blank frames and other objective criteria. For example, a perceptual evaluation of speech quality (PESQ) process 164 (see FIG. 3) may be performed to perform a perceived quality analysis. In such embodiment, the test sever 107 may also receive the test file of the content which may serve as a reference against which degradation may be determined. Specifically, the content reconstructed from the log file may be compared to the original content in the test file.

In one embodiment, the present invention comprises computer program code products having a tangible computer readable medium containing computer program code for testing the mobile telephone device 102. Various programs for implementing the test scenario may be stored in memory of the respective computers 104, 106-108, telephone devices 102, and/or output devices 120. The program code at the mobile telephone device, for example, may include a user application for receiving a user input indicating a selection of a test, and a test application configured to receive test communications and create a log file of the received communication. The program code at the media server 106 may include a data structure comprising test files. The program code at the test server 107 may include a data structure include a set of test files and test scenarios. The program code at the test server 107 may include instructions for reconstructing the content from the test file, communication parameters such as codec settings (e.g., type, mode, packet size, and rate), instructions for generating a data stream for one or more user applications, along with one or more user applications for playing back the content.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of determining the quality of data services of a mobile telephone, comprising:
wirelessly receiving content in a plurality of data packets at the mobile telephone via a mobile telephone network;
storing in a memory reception sequence data comprising data of the sequence of reception of each data packet received;
storing in a memory reception timing data comprising data of the timing of the reception of each packet received;
providing the sequence data and the timing data to a remote computer; and
with the remote computer, determining a quality assessment of the received content based on the sequence data and the timing data.

2. The method according to claim 1, wherein the content is configured to be presented to an end user via an end user application and wherein determining a quality assessment comprises:
providing the data packets to an end user application in a sequence determined by the reception sequence data and spaced apart in time as determined by the reception timing data; and
determining a quality for a presentation of the content provided by the end user application.

3. The method according to claim 2, wherein determining the quality assessment for a presentation of the content comprises:
storing an output of the presentation from the end user application; and
assessing a quality of the output via use of a computer executable program code.

4. The method according to claim 2, wherein said determining the quality assessment for a presentation comprises receiving a quality assessment input from one or more human observers of the presentation.

5. The method according to claim 1, further comprising:
receiving transmission sequence data comprising data of the sequence of transmission of two or more data packets received; and
wherein said determining a quality assessment comprises processing the received reception timing data, reception sequence data, and transmission sequence data.

6. The method according to claim 5, further comprising receiving transmission timing data comprising data of the timing of the transmission of each data packet; and
wherein said determining a quality assessment comprises processing the received reception timing data, reception sequence data, transmission sequence data, and transmission timing data.

7. The method according to claim 1, wherein said determining a quality assessment comprises:
providing the received data packets to a mobile telephone in a sequence determined by the reception sequence data and spaced apart in time as determined by the reception time data;
wherein the mobile telephone is configured to process the provided data packets to output a presentation of the content; and
wherein said determining a quality assessment comprises determining a quality assessment for the presentation outputted by the mobile telephone.

8. The method according to claim 7, wherein said determining the quality assessment for the presentation, comprises:
storing the presentation from the mobile telephone in a memory; and
assessing a quality of the output via use of a computer executable program code.

9. The method according to claim 1, wherein the content comprises video content.

10. The method according to claim 1, wherein the content comprises audio content without a video component.

11. The method according to claim 1, further comprising storing in a memory reception packet size data comprising data of the size of each data packet received; and
wherein said determining the quality assessment of the received content is further based on the reception packet size data.

12. The method according to claim 1, wherein determining the quality assessment of the received content comprises determining a statistical parameter of the number of data packets received out of sequence.

13. The method according to claim 12, wherein said determining the quality assessment of the received content further comprises determining a delay in the reception of one or more received data packets.

14. The method according to claim 12, wherein said determining the quality assessment of the received content comprises determining a delay in the reception of one or more received data packets.

15. The method according to claim 12, wherein said determining the quality assessment of the received content comprises determining a statistical parameter of the number of data packets lost.

16. The method according to claim 1, wherein the content comprises voice over IP content.

17. A method of determining the quality of data services of a mobile telephone, comprising:
wirelessly receiving content as a data stream of data packets at the mobile telephone via a mobile telephone network;
storing in the memory reception sequence data comprising data of the sequence of reception of each data packet received;
storing in a memory reception timing data comprising data of the timing of the reception of each data packet received;
reconstructing the data stream by providing the received data packets to an end user application in a sequence determined by the reception sequence data and spaced apart in time as determined by the reception time data;
presenting the content with the end user application; and
determining a quality assessment for a presentation of the content provided by the end user application.

18. The method according to claim 17, wherein said determining a quality assessment of the content comprises:
storing an output of the presentation from the end user application; and
assessing a quality of the output via use of a computer executable program code.

19. The method according to claim 17, wherein the end user application is resident on a mobile telephone.

20. The method according to claim 17, wherein the end user application is resident on a computer.

21. The method according to claim 17, wherein the content comprises video content and the end user application comprises a video player.

22. The method according to claim 17, wherein said determining a quality assessment further comprises processing the reception timing data and reception sequence data.

23. The method according to claim 22, further comprising storing in memory reception packet size data comprising data of the size of each data packet received; and
wherein said determining the quality assessment of the received content further comprises processing the reception packet size data.

24. The method according to claim 17, wherein said reconstructing comprises reconstructing the data stream with at least some of the data packets out of sequence from a transmitted sequence.

25. A method of determining the quality of a communication of a mobile telephone receiving a plurality of data packets comprising content, comprising:
determining reception sequence data comprising data of the sequence of reception of each of the data packet received by the mobile telephone;
determining reception timing data comprising data of the timing of the reception of each of the data packets received by the mobile telephone;
reconstructing the data stream by providing the received data packets to an end user application in a sequence determined by the reception sequence data and spaced apart in time as determined by the reception time data;
presenting the content with the end user application; and
determining a quality assessment of the presentation of the content based on the output of the end user application.

26. The method according to claim 25, wherein said determining a quality assessment of the content comprises:
storing an output of the presentation from the end user application; and
assessing a quality of the output via use of a computer executable program code.

27. The method according to claim 25, wherein the end user application is resident on the mobile telephone.

28. The method according to claim 25, wherein the end user application is resident on a computer.

29. The method according to claim 25, wherein the content comprises video content and the end user application comprises a video player.

30. The method according to claim 25, wherein the quality assessment comprises a perceived quality assessment, the method further comprising:
comprises processing the reception timing data and reception sequence data and said quality assessment comprises a statistical quality assessment.

31. The method according to claim 25, wherein said determining a quality assessment further comprises processing the reception timing data and reception sequence data.

32. The method according to claim 25, wherein said reconstructing comprises reconstructing the data stream with at least some of the data packets out of sequence from a transmitted sequence.

33. A method of determining the quality of a communication of a mobile telephone receiving a plurality of data packets comprising content, comprising:
determining an order of reception of each of the data packet received by the mobile telephone;
comparing the order of reception of each data packet received with a packet sequence number in each data packet received by the mobile telephone;
identifying a portion of the data packets that are received by the mobile telephone out of order;
determining a number of data packets transmitted to the mobile telephone;
determining a portion of data packets lost; and
assessing a quality of data service based, at least in part, on the portion of data packets received out of order and the portion of data packets lost.

34. The method according to claim 33, further comprising determining timing data comprising data of the timing of the reception of each of the data packets received by the mobile telephone; and
wherein said assessing a quality of data services is further based on the timing data.
